(19) United States
(12) Patent Application Publication
(10) Pub. No.: US 2006/0081009 A1
(43) Pub. Date: Apr. 20, 2006

(54) Glass manufacturing system and method for using a cooling bayonet to reduce stress in a glass sheet

(76) Inventor: Jaime J. Maldonado, Lexington, KY (US)

Correspondence Address: CORNING INCORPORATED, SP-TI-3-1, CORNING, NY, 14831, US

(21) Appl. No.: 10/970,314

(22) Filed: Oct. 20, 2004

(51) Int. Cl. C03B 17/06

(52) U.S. Cl. 65/195; 65/355

(57) ABSTRACT

A glass manufacturing system (100) is described herein that incorporates a liquid cooled bayonet (102) which functions to extract heat from a glass sheet (105) in order to reduce areas of stress in the glass sheet (105). In one embodiment of the present invention, the liquid cooled bayonet (102a) has one cooling section (304) with an uniform outside diameter and a uniform emissivity coating such that the heat extraction is mostly uniform from one end to the other end of the glass sheet (105). In another embodiment of the present invention, the liquid cooled bayonet (102b and 102c) has different cooling sections (404a . . . 404e and 504a . . . 504g) that have different outside diameters and/or different emissivity coatings which enables it to preferentially cool and reduce stress in different areas of the glass sheet (105).

### BACKGROUND OF THE INVENTION

1. Field of the Invention

The present invention relates to a liquid cooled bayonet that extracts heat from a glass sheet to reduce stress in the glass sheet while the glass sheet is being manufactured in a glass manufacturing system.

2. Description of Related Art

Manufacturers of glass sheets (e.g., liquid crystal display (LCD) glass sheets) that can be used in devices like flat panel displays are constantly trying to enhance the glass manufacturing system to reduce the stress in the glass sheets. There are several problems that can occur whenever a glass sheet is stressed. For instance, a stressed glass sheet is likely to distort and change shape. One way to enhance the glass manufacturing system in order to reduce the stress in a glass substrate is the subject of the present invention.

### BRIEF DESCRIPTION OF THE INVENTION

The present invention includes a glass manufacturing system that incorporates a liquid cooled bayonet which functions to extract heat from a glass sheet in order to reduce areas of stress in the glass sheet. In one embodiment of the present invention, the liquid cooled bayonet has one cooling section with an uniform outside diameter and a uniform emissivity coating such that the heat extraction is mostly uniform from one end to the other end of the glass sheet. In another embodiment of the present invention, the liquid cooled bayonet has different cooling sections that have different outside diameters and/or different emissivity coatings which enables it to preferentially cool and reduce stress in different areas of the glass sheet. The present invention also includes: (1) a method for using a liquid cooled bayonet and a glass manufacturing system to produce a glass sheet; and (2) a glass sheet made by a glass manufacturing system that uses a liquid cooled bayonet.

### BRIEF DESCRIPTION OF THE DRAWINGS

A more complete understanding of the present invention may be had by reference to the following detailed description when taken in conjunction with the accompanying drawings wherein:

FIG. 1 is a block diagram of an exemplary glass manufacturing system that incorporates a liquid cooled bayonet which functions to extract heat from a glass sheet in order to reduce stress in the glass sheet in accordance with the present invention;

FIG. 2 is a perspective view that illustrates in greater detail how the liquid cooled bayonet can be positioned between a forming apparatus and a pull roll assembly of the exemplary glass manufacturing system shown in FIG. 1;

FIG. 3 is a block diagram illustrating in greater detail the configuration of a first embodiment of the liquid cooled bayonet shown in FIGS. 1 and 2 which has a body with one cooling section that has a uniform outside diameter and a uniform emissivity coating in accordance with the present invention;

FIG. 4 is a block diagram illustrating in greater detail the configuration of a second embodiment of the liquid cooled bayonet shown in FIGS. 1 and 2 which has a body with five independent cooling sections that have two different outside diameters and two different types of emissivity coatings in accordance with the present invention;

FIG. 5 is a block diagram illustrating in greater detail the configuration of a third embodiment of the liquid cooled bayonet shown in FIGS. 1 and 2 which has a body with seven independent cooling sections that have three different outside diameters and two different types of emissivity coatings in accordance with the present invention; and

FIG. 6 is a flowchart illustrating the basic steps of a preferred method for producing a glass sheet using the exemplary glass manufacturing system and the liquid cooled bayonet shown in FIGS. 1 and 2 in accordance with the present invention.

### DETAILED DESCRIPTION OF THE DRAWINGS

Corning Inc. has developed a process known as the fusion process (e.g., downdraw process) which forms high quality thin glass sheets that can be used in a variety of devices like flat panel displays. The fusion process is the preferred technique used today for producing glass sheets that are used in flat panel displays because these glass sheets have surfaces with superior flatness and smoothness when compared to glass sheets produced by other methods. A glass manufacturing system 100 configured in accordance with the present invention that uses the fusion process to make a glass sheet 105 is briefly described below but for a more detailed description about the fusion process itself reference is made to U.S. Pat. Nos. 3,338,696 and 3,682,609. The contents of these two patents are incorporated herein by reference.

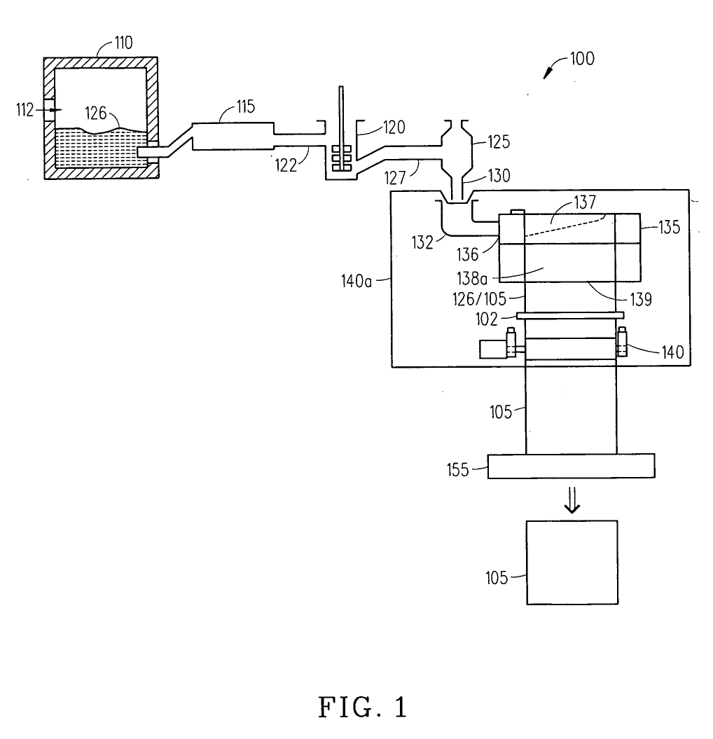

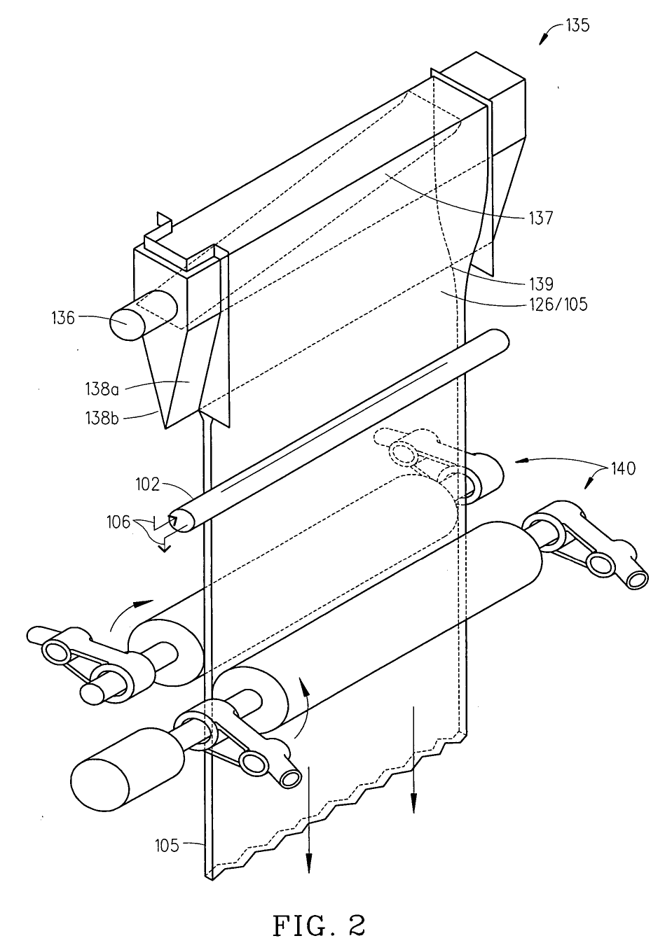

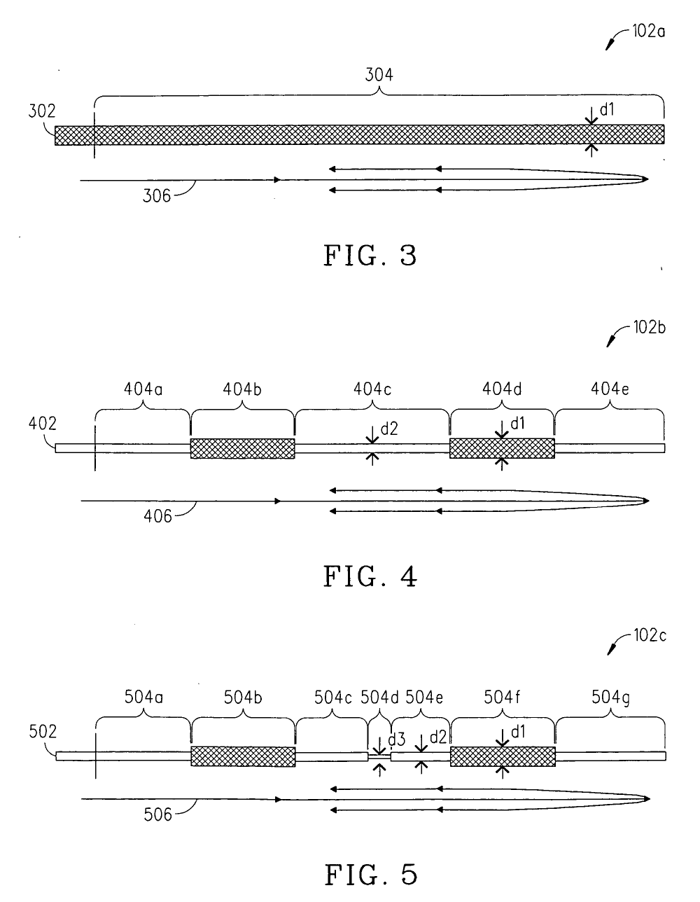

Referring to FIGS. 1 and 2, there are two different diagrams of an exemplary glass manufacturing system 100 that uses the fusion process and liquid cooled bayonet 102 of the present invention to make a glass sheet 105. As shown, the glass manufacturing system 100 includes a melting vessel 110, a fining vessel 115, a mixing vessel 120 (e.g., stir chamber 120), a delivery vessel 125 (e.g., bowl 125), a fusion draw machine (FDM) 140a, the liquid cooled bayonet 102 (only one shown) and a traveling anvil machine (TAM) 150. The melting vessel 110 is where the glass batch materials are introduced as shown by arrow 112 and melted to form molten glass 126. The fining vessel 115 (e.g., finer tube 115) has a high temperature processing area that receives the molten glass 126 (not shown at this point) from the melting vessel 110 and in which bubbles are removed from the molten glass 126. The fining vessel 115 is connected to the mixing vessel 120 (e.g., stir chamber 120) by a finer to stir chamber connecting tube 122. And, the mixing vessel 120 is connected to the delivery vessel 125 by a stir chamber to bowl connecting tube 127. The delivery vessel 125 delivers the molten glass 126 through a downcorner 130 into the FDM 140a which includes an inlet 132, a forming vessel 135 (e.g., isopipe 135), and a pull roll assembly 140. As shown, the molten glass 126 from the downcorner 130 flows into an inlet 132 which leads to the forming vessel 135 (e.g., isopipe 135). The forming vessel 135 includes an opening 136 that receives the molten glass 126 which flows into a trough 137 and then overflows and runs down two sides 138a and 138b before fusing together at what is known as a root 139. The root 139 is where the two sides 138a and 138b come together and where the two overflow walls of molten glass 126 rejoin (e.g., refuse) and form the glass sheet 105 which is drawn downward by the pull roll assembly 140. The TAM 150 then cuts the drawn glass sheet 105 into distinct pieces of glass sheets 105. As can be seen in FIG. 2, the liquid cooled bayonet 102 is located between the forming apparatus 135 and the pull roll assembly 140 and positioned near but not touching the glass sheet 105. It should be appreciated that the liquid cooled bayonet 102 can be located in anyone of a variety of positions like for example a vertical position or a diagonal position besides the shown horizontal position. The liquid cooled bayonet 102 which has liquid 106 flowing through it functions to absorb heat radiated from the glass sheet 105 to reduce temperature gradients which in turn reduces stress in the glass sheet 105. Several different embodiments of the liquid cooled bayonet 102 are described in detail below with respect to FIGS. 3-6.

Referring to FIG. 3, there is a block diagram illustrating in greater detail the configuration of a first embodiment of the liquid cooled bayonet 102a. The liquid cooled bayonet 102a has a round-shaped body 302 with one cooling section 304 that has a uniform outside diameter “d1” and a uniform emissivity coating (dark shade). The emissivity coating can be anyone of a wide variety of coatings such as a nickel alloy based coating. In operation, the bayonet 102a has a liquid 306 (e.g., water 306) that is cooled to a desired temperature flowing inside the body 302 which removes heat from the FDM 140a and in particular from the glass sheet 105 by allowing the surface of the body 302 to absorb heat radiated from the glass sheet 105. In this embodiment, the heat extraction is mostly uniform from one end to the other end of the bayonet 102a.

Referring to FIG. 4, there is a block diagram illustrating in greater detail the configuration of a second embodiment of the liquid cooled bayonet 102b. The liquid cooled bayonet 102b has a round-shaped body 402 with five independent cooling sections 404a, 404b, 404c, 404d and 404e each of which can have one of two different outside diameters “d1” and “d2” and one of two different types of emissivity coatings (dark shade and no shade). In this embodiment, the body 402 is configured and constructed in a manner which allows preferential cooling in prescribed locations along the glass sheet 105. The differential cooling of the glass sheet 105 is achieved by coating the surface of cooling sections 404a, 404b, 404c, 404d and 404e with different emissivity coatings or by changing the outside diameter “d1” or “d2” of the cooling sections 404a, 404b, 404c, 404d and 404e or by a combination of both. In operation, the bayonet 102b has a liquid 406 (e.g., water 406) that is cooled to a desired temperature flowing inside the body 402 which removes heat from the FDM 140a and in particular from certain areas more so than other areas along the glass sheet 105 by allowing the surface of the body 402 to differentially absorb heat radiated from the glass sheet 105. This differential cooling can be aligned with areas of high stress on the glass sheet 105 to provide stress level reduction. For example, in the liquid cooled bayonet 102b shown the cooling sections 404b and 404d would be located next to areas of low stress in the glass sheet 105. And, the cooling sections 404a, 404c and 404e would be located next to areas of high stress in the glass sheet 105.

To design the differential liquid cooled bayonet 102b, one may need to use a measuring device (not shown) to identify the horizontal stress profile in the glass sheet 105 that is made in a particular glass manufacturing system 100. The horizontal stress profile should be similar for all of the glass sheets 105 that are subsequently made on that glass manufacturing system 100. This stress profile is then used to design the bayonet 102b. For instance, areas of high tensile stress in the glass sheet 105 require less heat extraction by the bayonet 102b to reduce those stress levels in the glass sheet 105. Conversely, areas of high compressive stress in the glass sheet 105 require additional cooling capacity by the bayonet 102b to reduce those stress levels in the glass sheet 105. In the differential liquid cooled bayonet 102b, less cooling is achieved by reducing the outside diameter (reduction of heat transfer area) in a portion of the body 402 or by reducing the surface emissivity coating (reduction in radiation absorbed by the surface) on a portion of the body 402 or a combination of reducing the outside diameter and surface emissivity coating. And, more cooling is achieved by increasing the outside diameter (increase in the heat transfer area) in a portion of the body 402 or by increasing the surface emissivity coating (increase in radiation absorbed by the surface) on a portion of the body 402 or a combination of increasing the outside diameter and surface emissivity coating.

To make the differential liquid cooled bayonet 102b, tubes 404a, 404b, 404c, 404d and 404e of different diameters “d1” and “d2” are welded together to obtain the desired cross sectional area and coatings with different emissivity are applied to the surfaces thereof to obtain the desired radiation heat transfer control. In practice, the size, diameter and emissivity of the higher cooling sections 404b and 404d and the lower cooling sections 404a, 404c and 404e can be adjusted if desired so its total heat extraction matches the total heat extraction of a uniform cooling bayonet 102a (see FIG. 3). An advantage of using this liquid cooled bayonet 102b or any other liquid cooled bayonet 102 is that by absorbing heat one can reduce that stress in the glass sheet 105 and at the same time minimize the changes to other quality attributes in the glass sheet 105. These other quality attributes include for example: (1) out of plane deviation or flatness for the glass sheet 105 while it is hot inside the FDM 140a and while it is cold after being cut by the TAM 150; (2) the width of the glass sheet 105; and (3) the average thickness of the glass sheet 105.

Referring to FIG. 5, there is a block diagram illustrating in greater detail the configuration of a third embodiment of the liquid cooled bayonet 102c. The liquid cooled bayonet 102c has a round-shaped body 502 with seven different independent cooling sections 504a, 504b . . . 504g each of which can have one of three different outside diameters “d1”, “d2” and “d3” and one of two different types of emissivity coatings (dark shade and no shade). The liquid cooled bayonet 102c operates like the aforementioned bayonets 102a and 102b in which a liquid 506 (e.g., water 506) that is cooled to a desired temperature flows inside the body 502 to remove heat from the FDM 140a and in particular from certain areas more so than other areas along the glass sheet 105 by allowing the surface of the body 502 to differentially absorb heat radiated from the glass sheet 105. The purpose of adding this drawing is to show that the liquid cooled bayonet 102 can be configured and constructed in many different ways to enable preferential cooling in prescribed locations along the glass sheet 105. As such, it should be appreciated that a differential liquid cooled bayonet 102 can have any number of cooling sections that have a variety of diameters and that may or may not be coated with different surface emissivity coatings.

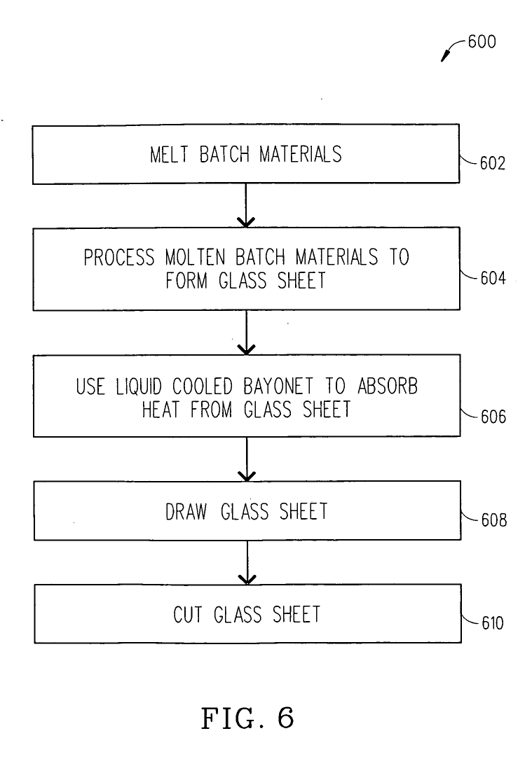

Referring to FIG. 6, is a flowchart illustrating the basic steps of a preferred method 600 for producing a glass sheet 105 using the glass manufacturing system 100 and liquid cooled bayonet 102 of the present invention. Beginning at steps 602 and 604, the glass manufacturing system 100 and in particular the melting vessel 110, the fining vessel 115, the mixing vessel 120, the delivery vessel 125 and the forming apparatus 135 are used to melt batch materials and process the molten batch material to form the glass sheet 105 (see FIG. 1). At step 606, the liquid cooled bayonet 102 is used to absorb heat radiated from the formed glass sheet 105 when it is located below the forming apparatus 135 so as to reduce stress in the formed glass sheet 105 (see FIGS. 2-5). At step 608, the formed glass sheet 105 is then drawn between two rolls in the pull roll assembly 140 (see FIG. 2). Then at step 610, the drawn glass sheet 105 is cut by the TAM 150 into individual glass sheets 105 (see FIG. 1). It should be appreciated that the configuration of the glass manufacturing system 100 and the bayonets 102a, 102b and 102c described herein are exemplary and that other glass manufacturing systems and different configurations of the bayonet 102 can be used to make glass sheets 105 in accordance with the present invention.

From the foregoing, it can be readily appreciated by those skilled in the art that the present invention includes a liquid cooled bayonet 102 that extracts heat from a glass sheet 105 to reduce temperature gradients which in turn reduces stress in the glass sheet 105 while the glass sheet 105 is being manufactured in a glass manufacturing system 100. The liquid cooled bayonet 102 which uses a cold surface to reduce temperature gradients and hence reduce the stress in the glass sheet 105 is able to do so with minimal negative effects on the different quality attributes in the glass sheet 105. These different quality attributes include for example: (1) out of plane deviation or flatness for the glass sheet 105 while it is hot inside the FDM 140a and while it is cold after being cut by the TAM 150; (2) the width of the glass sheet 105; and (3) the average thickness of the glass sheet 105.

Following are some additional features and advantages associated with the present invention:
Although the bayonet 102 is described above as being used in a glass manufacturing system 100 that uses a fusion process to make a glass sheet 105. It should be understood that the bayonet 102 could be used in any type of glass manufacturing system that draws molten glass to make a glass sheet 105.
Although only one round-shaped bayonet 102 is described above as being used in the glass manufacturing system 100. It should be understood that more than one bayonet 102 can be used in the glass manufacturing system 100. It should also be understood that the bayonet 102 can be any shape and can be made from many different types of materials including for example a metal.
It should also be appreciated that the present invention also includes the use of a bayonet (or electrical winding) that emits different degrees of heat from different areas on the bayonet instead of emitting cold to reduce the stress in a glass sheet 105.
The preferred glass sheets 105 made using the glass manufacturing system 100 are aluminosilicate glass sheets, borosilicate glass sheets or boro-alumino silicate glass sheets.
The present invention is particularly useful for forming high strain point glass sheets 105 like the ones used in flat panel displays. Moreover, the present invention could aid in the manufacturing of other types of glass sheets 105.

It should be appreciated that the bayonet 102 can be cooled by air or gas instead of by liquid if desired.

Although several embodiments of the present invention have been illustrated in the accompanying Drawings and described in the foregoing Detailed Description, it should be understood that the invention is not limited to the embodiments disclosed, but is capable of numerous rearrangements, modifications and substitutions without departing from the spirit of the invention as set forth and defined by the following claims.

What is claimed is:

1. A bayonet characterized by a body that is cooled such that said body can absorb heat radiated from a glass sheet while the glass sheet is being made in a glass manufacturing system.

2. The bayonet of claim 1, wherein said body is a liquid cooled body.

3. The bayonet of claim 1, wherein said body is configured and constructed in a manner which enables said body to preferentially cool and reduce stress in different areas of the glass sheet.

4. The bayonet of claim 1, wherein said body has different sections that are coated with different emissivity coatings which enables said body to preferentially cool and reduce stress in different areas of the glass sheet.

5. The bayonet of claim 1, wherein said body has different sections that have different outside diameters which enables said body to preferentially cool and reduce stress in different areas of the glass sheet.

6. The bayonet of claim 1, wherein said body has different sections that have different outside diameters and/or different emissivity coatings which enables said body to preferentially cool and reduce stress in different areas of the glass sheet.

7. The bayonet of claim 1, wherein said body has at least one lower cooling section and at least one higher cooling section which enables said bayonet to preferentially cool and reduce stress in different areas of the formed glass sheet.

8. The bayonet of claim 7, wherein:
each lower cooling section has a reduced outside diameter or is coated with a reduced emissivity coating or has a combination of the reduced outside diameter and the reduced emissivity coating; and
each higher cooling section has an enlarged outside diameter or is coated with a higher emissivity coating or has a combination of the enlarged outside diameter and the higher emissivity coating.

9. A glass manufacturing system characterized by:
at least one vessel for melting batch materials and forming molten glass;
a forming apparatus for receiving the molten glass and forming a glass sheet;
a cooled bayonet for absorbing heat radiated from the formed glass sheet;
a draw machine for drawing the formed glass sheet; and
a cutting machine for cutting the drawn glass sheet into individual glass sheets.

10. The glass manufacturing system of claim 9, wherein said bayonet is a liquid cooled bayonet.

11. The glass manufacturing system of claim 9, wherein said bayonet is configured and constructed in a manner which enables said bayonet to preferentially cool and reduce stress in different areas of the formed glass sheet.

12. The glass manufacturing system of claim 9, wherein said bayonet has at least one lower cooling section and at least one higher cooling section which enables said bayonet to preferentially cool and reduce stress in different areas of the formed glass sheet.

13. The glass manufacturing system of claim 12, wherein:
each lower cooling section has a reduced outside diameter or is coated with a reduced emissivity coating or has a combination of the reduced outside diameter and the reduced emissivity coating; and
each higher cooling section has an enlarged outside diameter or is coated with a higher emissivity coating or has a combination of the enlarged outside diameter and the higher emissivity coating.

14. A method for manufacturing a glass sheet, said method characterized by the steps of:
melting batch materials to form molten glass;
processing the molten glass to form the glass sheet;
using a bayonet that is cooled such that said bayonet can absorb heat radiated from the formed glass sheet;
drawing the formed glass sheet; and
cutting the drawn glass sheet into individual glass sheets.

15. The method of claim 14, wherein said bayonet is a liquid cooled bayonet.

16. The method of claim 14, wherein said bayonet is configured and constructed in a manner which enables said bayonet to preferentially cool and reduce stress in different areas of the formed glass sheet.

17. The method of claim 14, wherein said bayonet has at least one lower cooling section and at least one higher cooling section which enables said bayonet to preferentially cool and reduce stress in different areas of the formed glass sheet.

18. The method of claim 17, wherein:
each lower cooling section has a reduced outside diameter or is coated with a reduced emissivity coating or has a combination of the reduced outside diameter and the reduced emissivity coating; and
each higher cooling section has an enlarged outside diameter or is coated with a higher emissivity coating or has a combination of the enlarged outside diameter and the higher emissivity coating.

19. A glass sheet formed by a glass manufacturing system that is characterized by:
at least one vessel for melting batch materials and forming molten glass;
a forming apparatus for receiving the molten glass and forming a glass sheet;
a cooled bayonet for absorbing heat radiated from the formed glass sheet;
a draw machine for drawing the formed glass sheet; and
a cutting machine for cutting the drawn glass sheet into individual glass sheets.

20. The glass sheet of claim 19, wherein said bayonet has at least one lower cooling section and at least one higher cooling section which enables said bayonet to preferentially cool and reduce stress in different areas of the formed glass sheet.

21. The glass sheet of claim 20, wherein:
each lower cooling section has a reduced outside diameter or is coated with a reduced emissivity coating or has a combination of the reduced outside diameter and the reduced emissivity coating; and
each higher cooling section has an enlarged outside diameter or is coated with a higher emissivity coating or has a combination of the enlarged outside diameter and the higher emissivity coating.
